(19) United States
(12) Patent Application Publication
(10) Pub. No.: US 2020/0298240 A1
(43) Pub. Date: Sep. 24, 2020

(54) SAMPLING SYSTEMS AND TECHNIQUES FOR DETECTION OF HAZARDOUS CONTAMINANTS

(71) Applicant: Becton, Dickinson and Company, Franklin Lakes, NJ (US)

(72) Inventors: Matthew Oshinski, Oak Ridge, NJ (US); Christian Sandmann, Wayne, NJ (US); Austin Jason Mckinnon, Herriman, UT (US)

(21) Appl. No.: 16/822,713

(22) Filed: Mar. 18, 2020

Related U.S. Application Data
(60) Provisional application No. 62/821,233, filed on Mar. 20, 2019.

(51) Int. Cl. B01L 9/00

(52) U.S. Cl. CPC B01L 9/00; B01L 2300/0663; B01L 2300/021; B01L 2300/023; B01L 2300/024

(57) ABSTRACT

Certain aspects relate to systems and usage techniques for hazardous contamination detection devices that can utilize location-specific machine-readable information tags in conjunction with optical analysis of assays such as lateral flow assays to enable enhanced reliability and analysis of contamination detection data and/or trends. Location tags affixed to test locations and/or test sample containers provide for consistent and simplified testing workflows for reliably obtaining and storing location information in association with a large number of individual test results without requiring manual recordkeeping. Hazardous contamination detection devices can programmatically implement a two-step testing workflow.

### CROSS REFERENCE TO RELATED APPLICATION

This application claims the benefit of U.S. Provisional Application No. 62/821,233, filed Mar. 20, 2019, which is hereby incorporated by reference in its entirety.

### TECHNICAL FIELD

The systems and methods disclosed herein are directed to environmental contaminant testing, and, more particularly, to systems and devices for efficient multi-point contamination testing and tracking.

### BACKGROUND

Antineoplastic drugs are used to treat cancer, and are most often found in a small molecule (like fluoruracil) or antibody format (like Rituximab). Detection of antineoplastic drugs is critical for determining if there is contamination or leakage where the drugs are used and/or dispensed, such as hospital and pharmacy areas.

The nature of antineoplastic drugs make them harmful to healthy cells and tissues as well as the cancerous cells. Precautions should be taken to eliminate or reduce occupational exposure to antineoplastic drugs for healthcare workers. Pharmacists who prepare these drugs and nurses who may prepare and administer them are the two occupational groups who have the highest potential exposure to antineoplastic agents. Additionally, physicians and operating room personnel may also be exposed through the treatment of patients, as patients treated with antineoplastic drugs can excrete these drugs. Hospital staff, such as shipping and receiving personnel, custodial workers, laundry workers and waste handlers, all have the potential to be exposed to these drugs during the course of their work. The increased use of antineoplastic agents in veterinary oncology also puts these workers at risk for exposure to these drugs.

### SUMMARY

Antineoplastic drugs are antiproliferative. In some cases they affect the process of cell division by damaging DNA and initiating apoptosis, a form of programmed cell death. While this can be desirable for preventing development and spread of neoplastic (e.g., cancerous) cells, antineoplastic drugs can also affect rapidly dividing non-cancerous cells. As such, antineoplastic drugs can suppress healthy biological functions including bone marrow growth, healing, hair growth, and fertility, to name a few examples.

Studies have associated workplace exposures to antineoplastic drugs with health effects such as skin rashes, hair loss, infertility (temporary and permanent), effects on reproduction and the developing fetus in pregnant women, increased genotoxic effects (e.g., destructive effects on genetic material that can cause mutations), hearing impairment and cancer. These health risks are influenced by the extent of the exposure and the potency and toxicity of the hazardous drug. Although the potential therapeutic benefits of hazardous drugs may outweigh the risks of such side effects for ill patients, exposed health care workers risk these same side effects with no therapeutic benefit. Further, it is known that exposures to even very small concentrations of antineoplastic drugs may be hazardous for workers who handle them or work near them, and for known carcinogenic agents there is no safe level of exposure.

Environmental sampling can be used to determine the level of workplace contamination by antineoplastic agents. Sampling and decontamination of contaminated areas is complicated, however, by a lack of quick, inexpensive methods to first identify these areas and then determine the level of success of the decontamination. Although analytical methods are available for testing for the presence of antineoplastic drugs in environmental samples, these methods require shipment to outside labs, delaying the receipt of sampling results.

In one example sampling system suitable for use with the devices of the present disclosure, work surfaces can be tested for the presence of antineoplastic agents in an environment. Results of the test can be provided very quickly, at the site of testing, so that the operator of the test, other personnel in the area, and/or remote systems can be alerted to the presence and/or concentration of antineoplastic agents very close in time to the test event, in some cases within 1-2 minutes. Methods of testing include providing the surface with a buffer solution and wiping the wetted surface with an absorbent swab, or by wiping the surface with a swab pre-wetted with the buffer solution. The buffer fluid can have properties that assist in picking up contaminants from the surface. In some implementations, the buffer fluid can have properties that assist in releasing collected contaminants from swab material. The collected contaminants can be mixed into a homogeneous solution for testing. The buffer solution, together with any collected contaminants, can be expressed or extracted from the swab to form a liquid sample. This liquid sample can be analyzed for presence and/or quantity of specific antineoplastic agents. For example, the solution can be provided onto an assay (such as but not limited to a lateral flow assay) which is read by an assay reader device to identify presence and/or a concentration of the contaminant in the liquid sample.

Testing for the presence and/or concentration of a contaminant may be performed for several different locations within a facility. In some implementations, it may be desirable to maintain and analyze historical data and/or trends regarding contaminant detection. For example, an operator may wish to track increases or decreases in contaminants detected over time, across an entire facility and/or broken down by location subsets, by individual locations, by individual contaminant handlers, by individual contaminant detection testers, etc. Existing sampling systems require manual record-keeping that may be tedious and inefficient when implemented in a relatively large facility with a large number of individual testing locations. This approach has a number of drawbacks including being relatively time-consuming, being subject to record keeping or data entry errors, and increasing the risk of exposure of the test operator to potential hazardous drug contamination by increasing the amount of time the test operator must spend dealing with potentially hazardous samples.

These and other problems are addressed in embodiments of the hazardous drug collection and detection systems described herein, which include location-specific machine-readable information tags and diagnostic devices configured to determine location information based on the machine-readable information tags. The machine-readable information tags may be applied to sample collection containers and/or may be located at or near individual testing locations. The tags may be scanned at the time of sample collection and/or at the time of testing to ensure that each sample test result is stored in association with an accurate location identifier. The present technology thus provides improved accuracy for tracking and analyzing samples to detect presence or absence of hazardous contaminants and in some cases detected hazardous drug concentrations. The disclosed detection systems can advantageously enable more efficient and accurate analysis, categorization, and response to detected contamination events.

Accordingly, one aspect relates to a hazardous contamination detection device comprising a housing configured to receive an assay cartridge at least partially within the housing, the assay cartridge containing an assay; an optical sensor within the housing positioned to detect changes in optical characteristics of the assay following application of a test sample to the assay, the optical sensor configured to generate a signal indicating the detected changes in optical characteristics of the assay; a first optical scanner configured to image first machine-readable data from an object external to the housing; a second optical scanner within the housing configured to image second machine-readable data from the assay cartridge when it is at least partially received within the housing; at least one processor; and a memory having instructions stored thereon. The instructions configure the at least one processor to determine, based on the first machine-readable data imaged at the first optical scanner, location information identifying a test location corresponding to the assay cartridge; determine, based on the second machine-readable data imaged at the second optical scanner, additional information associated with the assay; determine a test result based at least partly on the additional information and the signal generated by the optical sensor; and automatically store the test result in association with the location information in the memory.

In some embodiments of the hazardous contamination detection device, the at least one processor is configured to use the additional information to establish operating parameters of the hazardous contamination detection device.

In some embodiments of the hazardous contamination detection device, the assay comprises a lateral flow assay, and the signal generated by the optical sensor is indicative of a positive or negative result corresponding to the assay.

In some embodiments of the hazardous contamination detection device, the additional information identifies a contaminant the assay is configured to detect.

In some embodiments of the hazardous contamination detection device, the assay is configured to detect the presence of one or more antineoplastic agents within a liquid sample applied to the assay.

In some embodiments of the hazardous contamination detection device, the at least one processor is configured to store the additional information in association with the test result.

In some embodiments of the hazardous contamination detection device, the additional information comprises at least one of a development time corresponding to the assay, an operating parameter for the hazardous contamination detection device corresponding to the assay, and a name corresponding to a drug the assay is configured to detect.

Some embodiments of the hazardous contamination detection device further comprise a communication module configured for wireless data transmission, and the instructions further configure the at least one processor to cause the communication module to wirelessly transmit, to a remote data store, the test result in association with the location information.

In some embodiments of the hazardous contamination detection device, the first machine-readable data and the second machine-readable data each comprise a barcode, and wherein the first optical scanner and the second optical scanner each comprises a barcode scanner.

Some embodiments of the hazardous contamination detection device further comprise a display and a sensor configured to detect insertion of the assay cartridge into the housing, and the instructions further configure the at least one processor to detect insertion of the assay cartridge into the housing; display, in response to detecting insertion of the assay cartridge, an instruction to a user to scan the first machine-readable data at the first optical scanner; and cause the first optical scanner to image the first machine-readable data.

Some embodiments of the hazardous contamination detection device further comprise a sensor configured to detect insertion of the assay cartridge into the housing, and the instructions further configure the at least one processor to detect insertion of the assay cartridge in the housing; and cause the second optical scanner to image the second machine-readable data.

In some embodiments of the hazardous contamination detection device, the memory stores a comma-separated values (CSV) file containing values indicative of previously performed tests, and storing the test result comprises editing the CSV file to add one or more values indicative of the test result and the location information.

In some embodiments of the hazardous contamination detection device, the first optical scanner is housed within a module removably received at least partially within the housing.

Another aspect relates to a method of location-specific testing for hazardous contaminants, the method comprising determining a plurality of test locations for hazardous contaminant testing; generating a plurality of location-specific machine-readable information tags, each machine-readable information tag associated with one of the plurality of test locations; collecting a first sample from a first test location of the plurality of test locations; applying the first sample to an assay disposed within a first assay cartridge, the assay cartridge comprising additional machine-readable information identifying a contaminant the assay is configured to detect; inserting the first assay cartridge into a hazardous contamination detection device; scanning, at an optical scanner of the hazardous contamination detection device, a first location-specific machine-readable information tag of the plurality of location-specific machine-readable information tags, the first location-specific machine-readable information tag associated with the first test location; and removing the first assay cartridge from the hazardous contamination detection device in response to an indication of a test result displayed by the hazardous contamination detection device.

Some embodiments of the method further comprise collecting a plurality of second samples from a plurality of second test locations of the plurality of test locations; applying the plurality of second samples to individual assays disposed within second assay cartridges; inserting individual second assay cartridges into the hazardous contamination detection device; and scanning, for each individual second assay cartridge, individual second location-specific machine-readable information tags of the plurality of location-specific machine-readable information tags, each second location-specific machine-readable information tag associated with a second test location corresponding to the individual second sample applied to the second assay cartridge. In some further embodiments of the method, collecting the plurality of second samples comprises placing each second sample into an individual sample container, the method further comprising, prior to inserting the individual second assay cartridges into the hazardous contamination detection device, affixing the individual second location-specific machine-readable information tags to the individual sample containers, wherein each individual second location-specific machine-readable information tag is scanned after the second sample contained therein has been at least partially transferred to an individual second assay cartridge. In some further embodiments of the method, affixing each individual second location-specific machine-readable information comprises obtaining one of a plurality of substantially identical tags stored at or near the corresponding second test location, and affixing the obtained tag to the individual sample container. In some further embodiments of the method, the individual second location-specific machine-readable information tags are affixed to second sample containers at a tag storage location remote from at least some of the plurality of test locations. In some further embodiments of the method, the hazardous contamination detection device is a portable device, wherein each first or second assay cartridge is inserted into the hazardous contamination testing device at or near one of the plurality of test locations, and wherein, for each first or second assay cartridge, the scanning comprises scanning a machine-readable information tag affixed to a surface at or near the one of the plurality of test locations.

In some embodiments of the method, scanning the first location-specific machine-readable information tag causes, at least in part, the hazardous contamination detection device to optically analyze the assay to determine a test result, and to append the determined test result and a test location identifier to a comma-separate values (CSV) file stored within a memory of the hazardous contamination detection device.

In some embodiments of the method, collecting the first sample comprises obtaining a liquid sample and storing the liquid sample within a sample container, the method further comprising affixing the first location-specific machine-readable information tag to the sample container.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A illustrates an example hazardous contamination detection device.

FIG. 1B illustrates an example assay cartridge compatible with the hazardous contamination detection device of FIG. 1A.

FIGS. 1C and 1D further illustrate example devices for obtaining a sample for analysis at hazardous contamination detection device of FIG. 1A.

FIG. 2 schematically illustrates an example medical facility in which the disclosed hazardous contamination detection systems and methods may be implemented.

FIG. 3 illustrates a schematic block diagram of an example hazardous contamination detection device.

FIG. 4 is a flowchart depicting an example operational process of a hazardous contamination detection device as disclosed herein.

FIG. 5 is a flowchart depicting an example process for location-specific testing using a hazardous contamination detection device as described herein.

FIG. 6 illustrates various examples of display text that can be presented to an operator on a display screen of an assay reader device as described herein.

FIGS. 7A-7D schematically illustrate example implementations for location-specific hazardous contamination testing of a plurality of test locations within a facility.

FIGS. 7E-7H illustrate example configurations for provision of location-specific machine-readable information tags compatible with the implementations of FIGS. 7A-7D.

FIGS. 8A-8C illustrate example reports generated in accordance with the location-specific hazardous contamination detection systems and methods described herein.

### DETAILED DESCRIPTION

### Introduction

Embodiments of the disclosure relate to systems and techniques for hazardous contaminant assay reader devices that can include a scanning input device for receiving location information and automatically associating the location information with determined test results. Embodiments of the reader devices can be portable, for example relatively small and light with an option to run off of stored power. The disclosed reader devices can be used in hospitals, clinics, doctors' and veterinary offices, and any treatment, care, or drug handling facilities where hazardous substances (such as but not limited to antineoplastic agents) are present, to enable rapid detection, categorization, and tracking of hazardous contaminants. A network connectivity module and/or manual data retrieval can enable standardizing, tracking and electronically connecting test results from reader devices located throughout a network for improved handling of hazardous substances.

The assay reader device can be a two-step device wherein the user need only apply the sample and scan a location-specific machine-readable information tag prior to viewing the result and optionally having the result transmitted to appropriate databases. Such a two-step device can obviate the necessity of performing complicated and time-consuming processing steps that may introduce errors in the end result. For example, a user may press a single button on the assay reader device to power the device on. Thereafter, insertion of a sample cartridge into the device can trigger an instruction to scan a location barcode; scanning the location barcode can automatically activate a reading process to determine and display a test result based on the previously-inserted sample cartridge without further user input. Location information may be received by scanning a location-specific tag (e.g., affixed to a sample container) at the reader device. The location tag affixed to each sample container allows the user to reliably scan the correct location tag corresponding to the location where the sample was obtained, without requiring the user to remember where individual samples were obtained, and while still permitting the user to collect a large number of samples during a single trip around the facility rather than having to return to the detector location after obtaining each sample. In some embodiments having network connectivity capabilities, the determined test result can additionally be automatically sent without requiring further user input to a remote storage device, for example to a centralized database. In some embodiments having network connectivity capabilities, the determined test result can be sent directly to the designated clinician or database. In some embodiments, the device can store each determined test result and associated location identifier in a memory, such as by adding one or more values to a comma-separated values (CSV) file storing previous test results and associated location identifiers.

One example of a device operation mode is end-point read mode. In the end-point read mode, the user prepares and incubates the assay outside of the assay analyzer device and tracks the development time of the assay. For example, an assay configured to determine the presence or absence of a hazardous drug can have a development time of 10 minutes, so the user would apply the specimen to the assay and wait for 10 minutes. At the end of the 10 minutes the user would insert the assay into the assay analyzer device to obtain a test result. Accordingly, when operating in end-point read mode the assay analyzer device can provide instructions, for example audibly or on a visual display, that instruct a user to wait for a predetermined time after applying a sample to an assay before inserting the assay in the assay analyzer device. In other embodiments, when operating in end-point read mode the assay analyzer device may not display any instructions but may simply read an assay upon insertion into the assay analyzer device. Upon insertion of the assay into the assay analyzer device, an optical reader of the device can collect image data representing the assay for analysis in determining a result of the assay. In some embodiments end-point read mode can be the default operation mode of an assay analyzer device.

Another example of a device operation mode is walkaway mode. Accordingly, when operating in walkaway mode the assay analyzer device can provide instructions for the user to insert the assay immediately after or during application of the sample. In the walkaway mode according to one embodiment, the user can apply the specimen to the assay and immediately insert the assay into the assay analyzer device. The assay will develop inside the assay analyzer device and the assay analyzer device can keep track of the time elapsed since insertion of the assay. At the end of the predetermined development time, the assay analyzer device can collect image data representing the assay, analyze the image data to determine a test result, and report the test result to the user. The assay development time can be unique to each test, for example a first contaminant assay development time can be 10 minutes, and a second contaminant assay development time can be 5 minutes. In some embodiments walkaway mode can be set by double-clicking the single button of the assay analyzer device. Further input can indicate the assay development time to the reader device. For example, a barcode scanned by a barcode reader or a barcode provided on the assay or on a cartridge used to house the assay, can indicate to the device a type of assay that is inserted and a development time for that assay. Based upon the type of assay, the assay analyzer device can wait for the predetermined amount of time after sample application and insertion before collecting image data representing the assay.

There are many advantages associated with the ability of a user to select and switch between device operation modes in implementations of assay analyzer devices described herein. The endpoint read mode can be convenient in large laboratories or medical practice facilities where personnel typically batch process a number of tests. The walkaway mode can be useful when a single test is being performed, or when the end user does not want to have to track the assay development time (or is not knowledgeable or not trained on how to track the assay development time accurately). The walkaway mode can advantageously reduce or eliminate the occurrence of incorrect test results due to an assay being inserted and imaged too quickly (too soon before the development time of the assay has elapsed) or too slowly (too long after the development time of the assay has elapsed). Further, in walkaway mode the assay reader can operate to capture multiple images of the assay at predetermined time intervals, for example when a kinetic graph of the assay readings is desired.

One embodiment of the disclosed assay analyzer device, such as a base assay reader device described in detail below, includes only a single button on its exterior housing, such as a single power button that powers the assay analyzer device off and on. Embodiments of the disclosed assay analyzer device also implement two different device operation modes (although more than two device operation modes are possible). In order to enable the end user to select and switch between the two device operation modes, the assay analyzer device can include instructions to implement a double-click function on the power button. After receiving input of a single press of the button to power on the device, insertion of an assay cartridge can automatically trigger end-point read mode. When the processor of the device receives input from a user double clicking the power button, this can initiate the stored instructions to implement the walkaway mode. This double click functionality offers a simple and intuitive way for the end user to switch between different operation modes of the assay analyzer device. The double click functionality also enables the user to configure the device in real time to operate in the walkaway mode without requiring any additional configuration steps or additional programming of the assay analyzer device by the user. It will be appreciated that the assay analyzer device can be provided with instructions to recognize other click modes instead of or in addition to the double click to trigger secondary (non-default) device operation modes, for example to recognize a user pressing the button any predetermined number of times, pressing the button in a predetermined pattern, and/or pressing and holding the button for a predetermined length of time.

Examples of barcode uses include, as described above, providing additional data for association with test result data, including location information, test type, device operation mode, sample information, and any other additional test or test location information pertinent to the test performed by the device. Some barcodes can unlock device functions. Some barcodes can provide or update various types of information the device uses to analyze an assay, determine a test result, or perform a function. For example, a scanned barcode can provide to the reader device assay or reader calibration information that is useful or necessary to perform the test. In embodiments in which the device does not have wireless network connectivity, test results can be stored in a memory of the reader device, and in order to access the stored test results a user can scan a password barcode using a barcode scanner associated with the reader device.

Although the disclosed devices are typically described herein as assay reader devices, it will be appreciated that the modular system design and network connectivity aspects described herein can be implemented in any suitable hazardous contaminant detection device. For example, features described herein can be implemented in reader devices that analyze other types of assays, such as but not limited to molecular assays, and provide a test result. In other examples, a collected fluid is transferred to a centrifuge, spectrometer, chemical assay, or other suitable test device to determine the presence and/or concentration of one or more hazardous substances in the sample. Accordingly, embodiments of the systems and methods according to the present disclosure that collect, test, and track collected samples can be implemented in these and other types of test systems, and are not limited to immunoassay test systems described herein.

Various embodiments will be described below in conjunction with the drawings for purposes of illustration. It should be appreciated that many other implementations of the disclosed concepts are possible, and various advantages can be achieved with the disclosed implementations.

### Overview of Example Assay Reader Devices and Operations

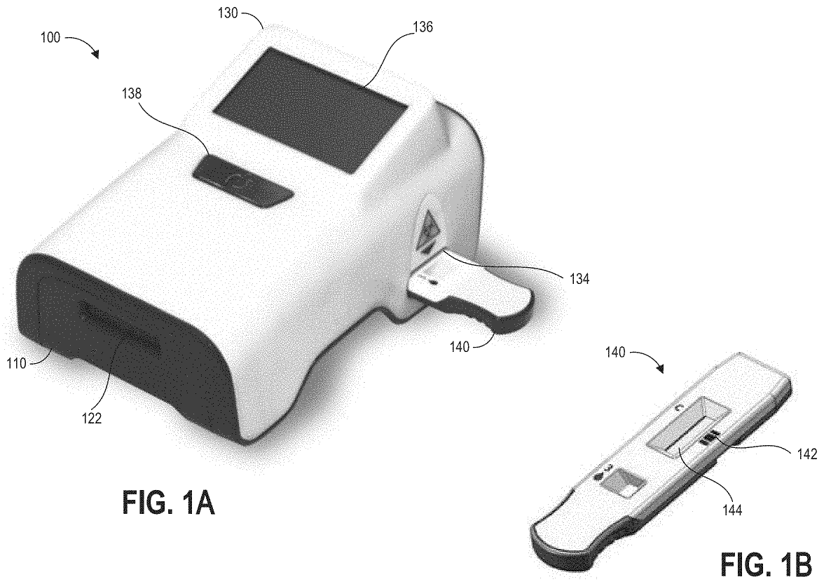

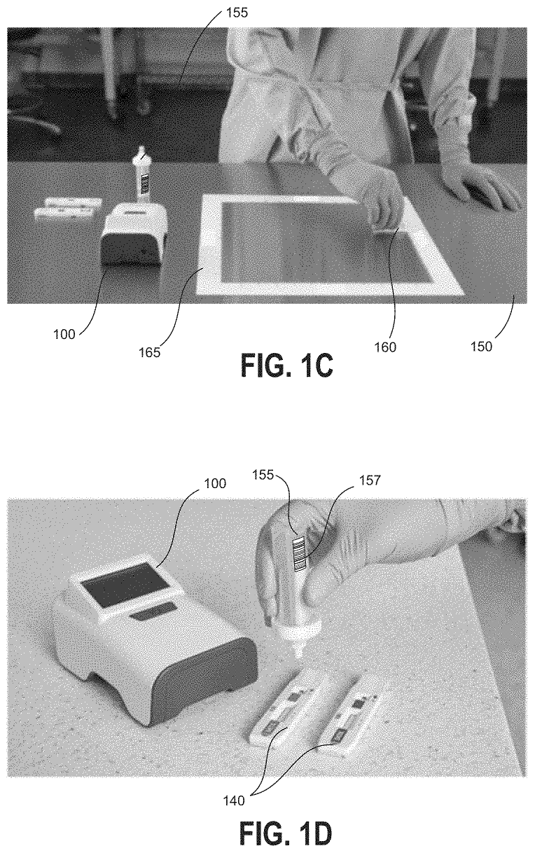

FIG. 1A illustrates an example hazardous contamination detection device 100. The hazardous contamination detection device 100 includes an external scanning module 110 and an assay reader device 130. In some embodiments, the external scanning module may be an interchangeable module that can be lockingly inserted into a bay of the assay reader device 130. An assay cartridge 140, further illustrated in FIG. 1B, includes an assay 144 for insertion into the hazardous contamination detection device. FIG. 1C illustrates a user obtaining a liquid sample at a test location for analysis by the hazardous contamination detection device 100. FIG. 1D illustrates a user applying the liquid sample from a sample container 155 to an assay within an assay cartridge 140

The hazardous contamination detection device 100 includes an external optical scanner 122, a cartridge receiving aperture 134, a display 136, and a button 138. The external optical scanner may be, for example, a barcode scanner or any other scanner capable of imaging or otherwise scanning or detecting machine-readable or human-readable information. In some embodiments, the hazardous contamination detection device 100 further includes an internal optical scanner (not visible in FIG. 1A) positioned to read a barcode 142 or other machine-readable or human-readable information printed on or otherwise affixed to a cartridge 140 when the cartridge has been inserted into the cartridge receiving aperture 134. The cartridge receiving aperture 134 can be sized and shaped to align a test region of an assay with a detector or detector array provided within the hazardous contamination detection device 100 when the assay cartridge 140 is inserted through the cartridge receiving aperture 134. For example, if the assay is lateral flow assay test strip the test region can include one or more of a control zone and a test zone having immobilized compounds that are capable of specifically binding the target analyte. The hazardous contamination detection device 100 can implement adaptive read technology to improve specificity of test results and to reduce false-positive results by compensating for background and non-specific binding. The hazardous contamination detection device 100 can be configured for fast and accurate assay performance. This can aid in rapid detection of the presence of one or more hazardous contaminants in a facility and facilitate a test-and-act-approach for mitigation of hazardous contamination.

Display 136 of the hazardous contamination detection device 100 can be an LED, LCD, OLED, or other suitable digital display and can implement touch-sensitive technologies in some embodiments. Button 138 can be a mechanical button for powering on the hazardous contamination detection device 100. As described above, the hazardous contamination detection device 100 can include instructions to recognize a pattern of presses of the single button 138 in order to select a device operation mode. In some embodiments, the hazardous contamination detection device 100 may power on and be readied for use automatically when plugged in or otherwise powered and thus button 138 may be omitted. In other embodiments, multiple buttons can be provided on the hazardous contamination detection device 100. The assay reader device can further include a processor and at least one memory, as discussed in more detail below. The hazardous contamination detection device 100 can be data storage and printing enabled.

The external optical scanner 122 can include one or more photodetectors and optionally light emitting devices, such as for reading barcodes or other machine-readable information. For example, one implementation of external optical scanner 122 can include a light source, a lens for focusing the light source onto an object, and a light sensor for receiving light reflected off of the object and translating the received light into electrical signals. Some implementations of a sensor of external optical scanner 122 can include an array of many tiny light sensors such that a voltage pattern generated by the array is substantially identical to the pattern in a barcode. The external optical scanner 122 can also include decoder circuitry or software for analyzing the image data provided by the sensor, identifying a barcode pattern in the image data, determining content associated with the barcode pattern, and outputting the content, for example to a processor of the assay reader device.

In some embodiments, the external optical scanner 122 can be used to scan location-specific machine-readable information tags. The machine-readable information tags can include location information such as a location identifier, for example, encoded into a barcode or other format, which can be scanned and stored in association with a test result, so as to ensure a high level of traceability and quality control via a customizable documentation functionality, data storage/download, and printing capability, while reducing manual transcription and risk of errors. As used herein, traceability can refer to the ability to verify the location, time, personnel, patient, or other information associated with a test performed using a reader device by means of documented information. The documented information can be advantageously accessed by numerous entities in a number of ways described herein. As described above, the external optical scanner can be used to enter test-related data, change device settings, unlock data access or other features, or to change the device mode. Test-related data can include test location, user ID, clinician or test administrator ID, specimen ID, and test kit lot and/or expiration, among other test-related information described herein. Multiple operating modes for the hazardous contamination detection device 100 provide a flexible workflow implemented via barcode scanning.

In some embodiments, a hazardous contamination detection device 100 can allow the end-user to configure preset functions such as whether to require an operator to input information regarding the identity of the operator at the start of each test or set of tests. For example, the preset function may require the operator to scan an operator ID barcode at the start of each testing event. The configuration of these preset functions can be accomplished by scanning a configuration barcode that, once decoded by the device, includes instructions for the preset function scanning configuration. In one implementation, a healthcare facility administrator can initially select, from a set of printed barcodes, one or more barcodes corresponding to the types of information required by the administrator's desired configuration for a particular reader device; subsequent to this initial configuration selection, a user in the healthcare facility using the particular reader device can scan the appropriate barcodes to input information corresponding to the pre-selected functions of the reader device. The reader device can transmit all available information related to the test to a centralized server, for example via a connectivity module or a wired connection to another computing device. In one implementation, compliance may not be enforced at the reader level, and if the end user provided operator ID via barcode scan then this information will be transmitted with the test result, otherwise the operator ID fields will be left blank. Other implementations can prompt the end user for the missing information. Local data storage, download, and print options can help to ensure compliance and traceability if the readers do not have wireless or cellular connectivity capabilities.

Cartridge 140 can house an assay 144 for proper alignment within the hazardous contamination detection device 100. As illustrated, cartridge 140 can include a window for exposing a test region of the assay 144. The assay 144 can be a hazardous contaminant detection assay, for example configured to detect the presence of an antineoplastic drug such as but not limited to methotrexate or doxorubicin, or any other type of diagnostic test that can be optically imaged to determine a test result. Cartridge 140 can also include a barcode 142 or other machine-readable information for providing test information, for example a type of test, that can be used in some embodiments to configure an automated process run by the hazardous contamination detection device 100 for determining a result of the assay. The user can scan the barcode 142 of the cartridge 140 using the external optical scanner 122, as a way to input information into the hazardous contamination detection device 100. Alternatively or additionally, an internal optical scanner of the hazardous contamination detection device 100 may be positioned so as to scan the barcode 142 while the assay cartridge 140 is inserted within assay cartridge receiving aperture 134 of the hazardous contamination detection device 100. Such information contained within the barcode 142 can include cartridge- or assay-specific information, such as an assay test type identifier or one or more operating parameters for performing the test, In other implementations, barcode 142 can include additional information, such as test location identification information, a barcode password for unlocking functions of the hazardous contamination detection device 100, and the like.

The hazardous contamination detection device 100 can include one or more additional data communications ports (not illustrated), for example a USB port. The port can be set up as a general purpose hardware interface for the hazardous contamination detection device 100. Using this interface, the hazardous contamination detection device 100 can support external peripherals, for example a printer or a keyboard. The port can enable the base hazardous contamination detection device 100 to be connected to a PC for data download. For example, when the hazardous contamination detection device 100 is connected to a PC via a USB interface, the reader device can function like a USB drive. In addition, the end user can update the reader device firmware by connecting a USB drive containing the latest firmware revisions to the USB port. Furthermore, the USB port offers a convenient way to upload assay calibration data into the reader device, for example lot specific calibration data.

Referring now to FIGS. 1C and 1D, a user may obtain a liquid sample at a test location in order to determine whether a hazardous contaminant is present at the test location. A surface 150 may be tested, for example, by using a swab 160 moistened with a buffer solution. In some embodiments, a template 165 may be used to define a testing area. After swabbing or otherwise obtaining a liquid sample from the surface 150, the swab 160 or a portion thereof may be placed into the sample container 155. The sample container 155 may be pre-labeled with a location-specific machine-readable information tag such as a barcode tag 157 corresponding to the individual test location. With reference to FIG. 1D, the user may then apply at least a portion of the liquid sample from the sample container 155 to one or more assay cartridges 140 which are insertable into the hazardous contamination detection device 100. It will be understood that various other sample collection techniques may equally be implemented with the embodiments of the present disclosure.

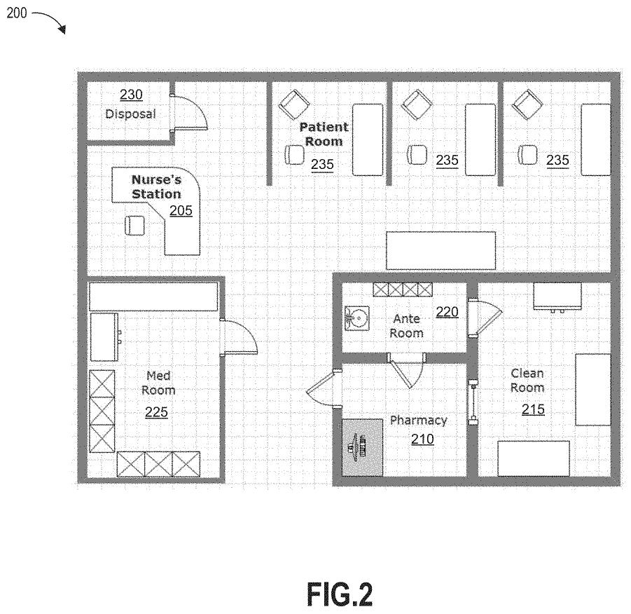

Referring now to FIG. 2, an example medical facility 200, in which the disclosed hazardous contamination detection systems and methods may be implemented, is schematically illustrated. As shown in FIG. 2, a medical facility 200, in which antineoplastic drugs or other hazardous contaminants may be used, can include a variety of locations in which the contaminants may be stored, administered, transported, or otherwise used. For example, the medical facility 200 may include areas such as a nurse's station 205, a pharmacy 210, a clean room 215, an ante room 220, a med room 225, a disposal room 230, and/or one or more patient rooms 235. Within each area, it may be desirable to test a plurality of locations, such as desks, tables, workstations, compounding hoods, chairs, beds, storage cabinets, medication inventory carts, counters, IV poles, floors, waste containers, etc., for the presence of hazardous contaminants that may be present. Such a large number of possible testing locations may allow for a high probability of errors in location tagging if manual recordkeeping is used to associate test locations with corresponding test results. Additionally, the time required to manually record the location of each test may be prohibitively time-consuming. The systems and methods described herein may improve the efficiency and accuracy of location-specific hazardous contamination testing.

As will be described in greater detail below, in one example implementation, a location-specific machine-readable information tag is located on each of the plurality of test locations and scanned by an operator during location-specific hazardous contamination testing according to the present disclosure. In another example implementation, location-specific machine-readable information tags are pre-printed and stored at each of the plurality of test locations, allowing the operator to quickly and easily affix one of the pre-printed tags to a sample container used for hazardous contamination testing when the operator arrives at the test location. In still another example implementation, an operator prints location-specific machine-readable information tags at each of the plurality of test locations (or at another station) and affixes the tags to sample containers before beginning location-specific hazardous contamination testing.

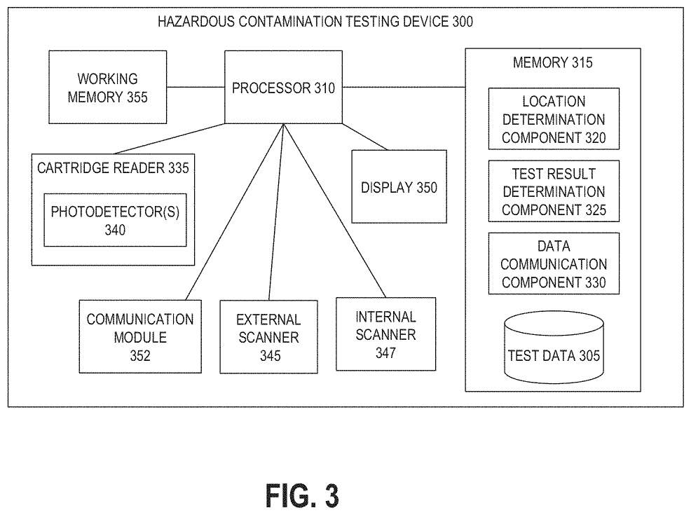

FIG. 3 illustrates a schematic block diagram of one possible embodiment of internal components of an example hazardous contamination detection device 300. The hazardous contamination detection device 300 can include one or more features of the hazardous contamination detection device 100 described above.

The components can include a processor 310 linked to and in electronic communication with a memory 315, working memory 355, cartridge reader 335, external scanner 345, display 350, and communication module 352.

The cartridge reader 335 can include one or more photodetectors 340 for reading an assay held in an inserted cartridge. The cartridge reader 335 can send image data from the one or more photodetectors to the processor 310 for analysis of the image data representing the imaged assay to determine a test result of the assay. The photodetector(s) 340 can be any device suitable for generating electric signals representing incident light, for example a PIN diode or array of PIN diodes, a charge-coupled device (CCD), or a complementary metal oxide semiconductor (CMOS) sensor, to name a few examples. The cartridge reader 335 can also include a component for detecting cartridge insertion, for example a mechanical button, electromagnetic sensor, or other cartridge sensing device. An indication from this component can instruct the processor 310 to begin an automated assay reading process without any further input or instructions from the user of the device 300. An example automated assay reading process is the walkaway mode described above.

External scanner 345 and internal scanner 347 may additionally comprise one or more photodetectors. The external scanner 345 and the internal scanner 347 can further send image data representing an imaged cartridge and/or an imaged location-specific machine-readable information tag for use in determining which one of a number of automated operating processes to implement for imaging the assay and/or determining a location identifier to store in association with a test result.

Processor 310 can be configured to perform various processing operations on image data received from the cartridge reader 335, external scanner 345, and/or internal scanner 347 in order to determine and store test result data, as will be described in more detail below. Processor 310 may be a general purpose processing unit implementing assay analysis functions or a processor specially designed for assay imaging and analysis applications. The processor 310 can be a microcontroller, a microprocessor, or ASIC, to name a few examples, and may comprise a plurality of processors in some embodiments.

As shown, the processor 310 is connected to a memory 315 and a working memory 355. In the illustrated embodiment, the memory 315 stores location determination component 320, test result determination component 325, data communication component 330, and test data repository 305. These modules include instructions that configure the processor 310 of device 300 to perform various location tagging, image processing, and device management tasks. Working memory 355 may be used by processor 310 to store a working set of processor instructions contained in the modules of memory 315. Alternatively, working memory 355 may also be used by the processor 310 to store dynamic data created during the operation of device 300.

As mentioned above, the processor 310 may be configured by several modules stored in the memory 315. The location determination component 320 may include instructions that control the detection of a location identifier at the external scanner 345. For example, location determination component 320 may include instructions that call subroutines to configure the processor 310 to perform functions such as instructing a user to scan a location barcode, detecting a location barcode scanned at the external scanner 345, and determining a location identifier based at least in part on the location barcode. The test result determination component 325 can include instructions that call subroutines to configure the processor 310 to analyze assay image data received from the photodetector(s) 340 to determine a result of the assay. For example, the processor can compare image data to a number of templates or pre-identified patterns to determine the test result. Other implementations are possible as will be recognized by a person of skill in the art. In some implementations, test result determination component 325 can configure the processor 310 to implement adaptive read processes on image data from the photodetector(s) 340 to improve specificity of test results and to reduce false-positive results by compensating for background and non-specific binding.

The data communication component 330 can cause local storage of test results and associated information, such as a location identifier determined by the location determination component 320, in the test data repository 305. If a local wired or wireless connection is established between the device 300 and another computing device, the data communication component 330 can prompt a user of the device 300 to scan a password barcode using an inserted module (for example, the external scanning module 110 implemented in hazardous contamination detection device 100 or the external scanner 345 implemented in the device 300) in order to access the data in the repository 305. In some embodiments, the data communication component 330 can further cause the communication module 352 to send or receive data from another computing device.

The processor 310 can be configured to control the display 350 to display captured image data, imaged barcodes, test results, and user instructions, for example. The display 350 may include a panel display, for example, a LCD screen, LED screen, or other display technologies, and may implement touch sensitive technologies.

Processor 310 may write data to data repository 305, for example data representing captured images of barcodes and assays, instructions or information associated with imaged barcodes, and determined test results. While data repository 305 is represented graphically as a traditional disk device, those with skill in the art will understand that the data repository 305 may be configured as any storage media device. For example, data repository 305 may include a disk drive, such as a hard disk drive, optical disk drive or magneto-optical disk drive, or a solid state memory such as a FLASH memory, RAM, ROM, and/or EEPROM. The data repository 305 can also include multiple memory units, and any one of the memory units may be configured to be within the hazardous contamination detection device 300, or may be external to the device 300. For example, the data repository 305 may include a ROM memory containing system program instructions stored within the assay reader device 300. The data repository 305 may also include memory cards or high speed memories configured to store captured images which may be removable from the device 300.

Although FIG. 3 depicts a device having separate components to include a processor, cartridge reader, module interface, and memory, one skilled in the art will recognize that these separate components may be combined in a variety of ways to achieve particular design objectives. For example, in an alternative embodiment, the memory components may be combined with processor components to save cost and improve performance.

Additionally, although FIG. 3 illustrates a number of memory components, including memory 315 comprising several modules and a separate memory 355 comprising a working memory, one of skill in the art will recognize several embodiments utilizing different memory architectures. For example, a design may utilize ROM or static RAM memory for the storage of processor instructions implementing the modules contained in memory 315. The processor instructions may be loaded into RAM to facilitate execution by the processor 310. For another example, working memory 355 may comprise RAM memory, with instructions loaded into working memory 355 before execution by the processor 310.

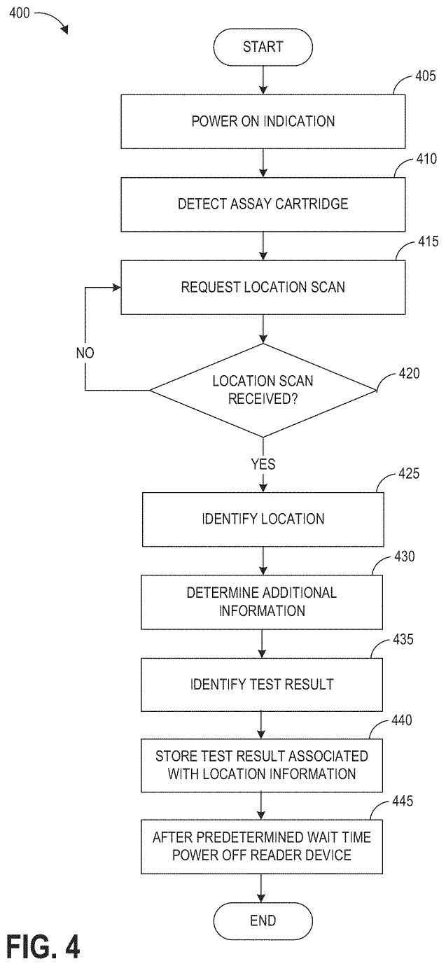

FIG. 4 is a flowchart depicting an example operations process 400 of a hazardous contamination detection device as disclosed herein. The process 400 can be implemented by a hazardous contamination detection device 100 and/or processor 310 in some embodiments.

At block 405, the processor 310 can receive a power on indication, for example in response to a user pressing a single button located on an assay reader device.

At block 410, the processor can detect the insertion of an assay cartridge, for example, the insertion of assay cartridge 140 into an assay cartridge receiving aperture 134.

At block 415, the hazardous contamination detection device 100 can request a location scan. For example, processor 310 can cause the display 350 to display an instruction prompting a user to scan a location-specific machine-readable information tag, such as a location barcode, at the external scanner 345 (e.g., external optical scanner 122). The user can scan a location-specific machine-readable information tag located at (for example, affixed to) a specific location where a test is to be conducted (such as but not limited to test locations indicated in FIG. 2), or a location-specific machine-readable information tag affixed to a sample container that will receive a collected sample.

It will be understood that block 415 can be implemented before 410.

At decision block 420, the processor 310 can determine whether a location scan was received. For example, the processor 310 may determine whether a barcode or other machine-readable information was imaged at the external scanner 345, and whether the imaged machine-readable information contains data formatted as a location identifier. If a location scan was not received (e.g., if no machine-readable information was imaged or the imaged machine-readable information did not contain a suitable location identifier), the method 400 may return to block 415 and the processor 310 may cause the display 350 to display again or continue displaying the user instruction requesting a location scan. If a location scan was received at decision block 420, the method 400 continues to block 425.

At block 425 the processor 310 can identify the location associated with the location scan. For example, the processor 310 can determine a location identifier comprising at least a portion of the machine-readable information. In some embodiments, the processor 310 may cause the determined location identifier or other location information to be stored in the working memory 355 and/or in the memory 315.

At block 430, the processor 310 can optionally determine one or more items of additional information. For example, the processor 310 may cause the internal scanner 347 to scan a barcode or other machine-readable information located on the inserted assay cartridge. In various embodiments, the additional information contained within a barcode on the assay cartridge may include, for example, information relating to the assay test such as a test type identifier, a substance detectable by the assay, one or more operating parameters for performing the test, and the like.

At block 435, the processor 310 determines a test result. In one example, the test result is determined by imaging the assay, and determining a test result based on the image data representing the assay. In some embodiments, the test result is determined based at least in part on the additional information determined at block 430. Block 435 can be implemented as any of the disclosed reader operation modes, for example an end-point read mode or a walkaway mode, or any other suitable mode.

At block 440, the processor 310 locally stores the test result together with any associated data, for example an image of the assay used to generate the test result and additional information provided via a scanned barcode. For example, the processor 310 stores the test result (e.g., positive or negative, and optionally an identifier of a contaminant being tested for) in association with the determined location information. In one example, the processor 310 locally stores the test result by editing a CSV file stored in the test data repository 305 to add one or more values identifying the test result and the test location. Additionally or alternatively, the processor 310 can transmit the test result and optionally any associated data to a destination database or contact person via a network. For example, this can be accomplished through the communication module 352.

At block 445, the processor 310 can wait for a predetermined time period before powering off the assay reader device. Additionally or alternatively, the hazardous contamination detection device 300 may be configured to be manually powered off.

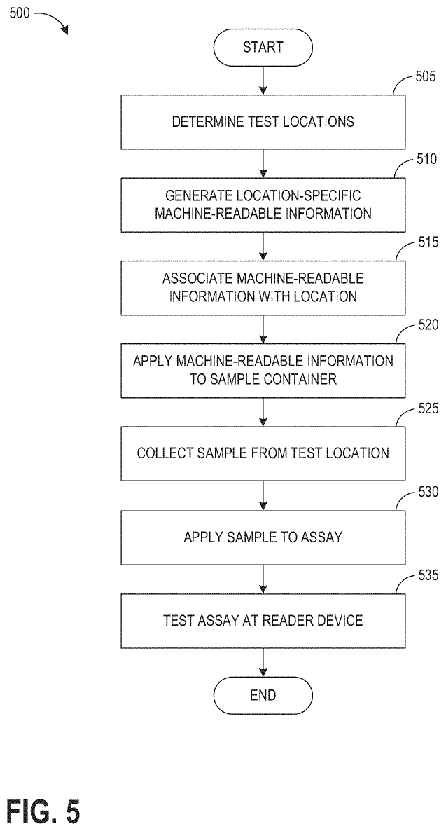

FIG. 5 is a flowchart depicting an example process 500 for location-specific testing using a hazardous contamination detection device as described herein. The process 500 can be implemented at least in part by a user and/or a hazardous contamination detection device 100 and/or processor 310 in some embodiments.

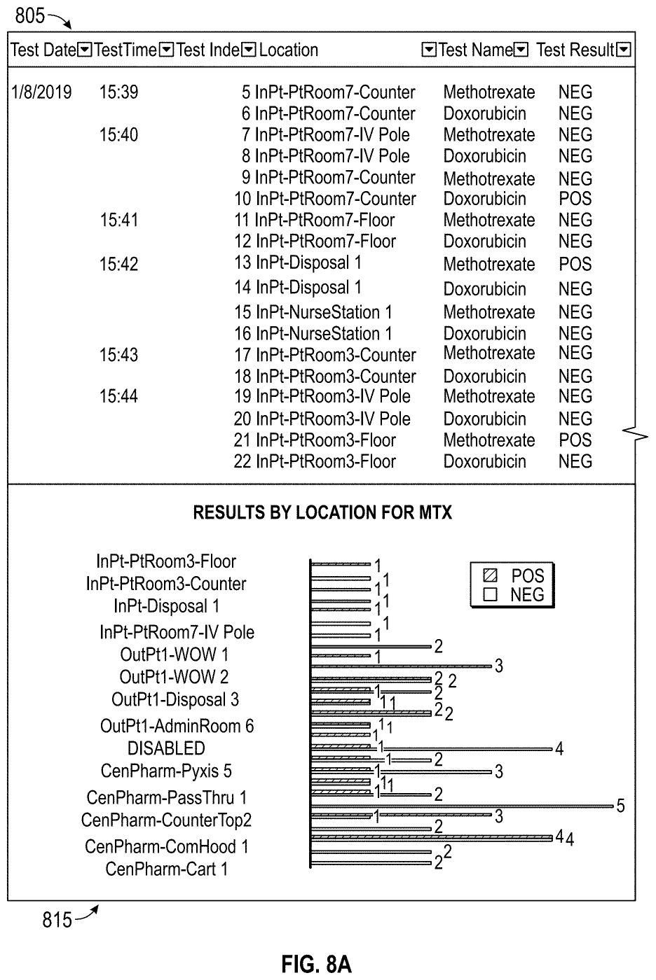

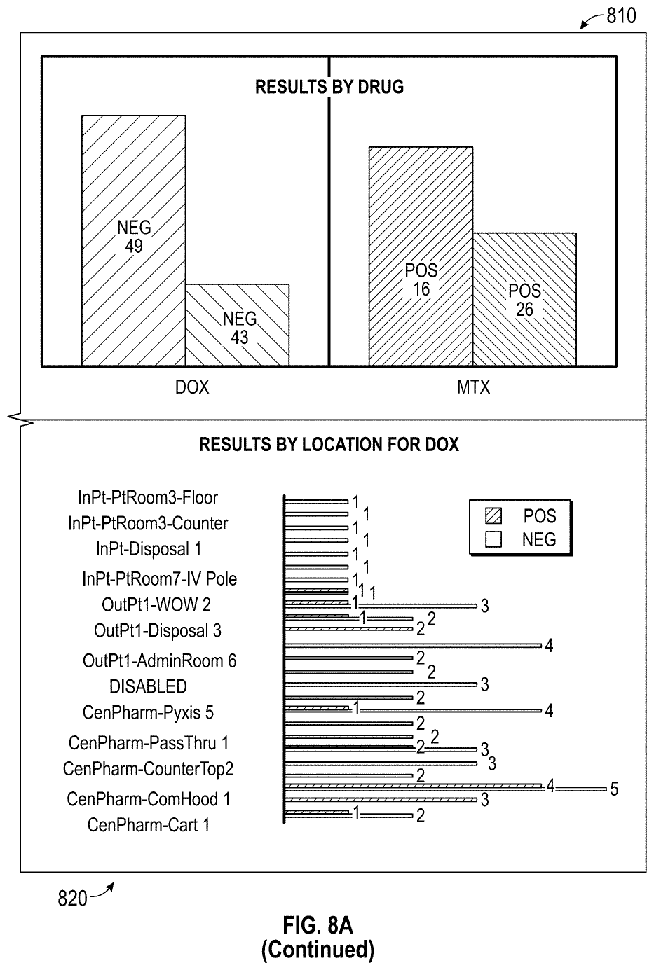

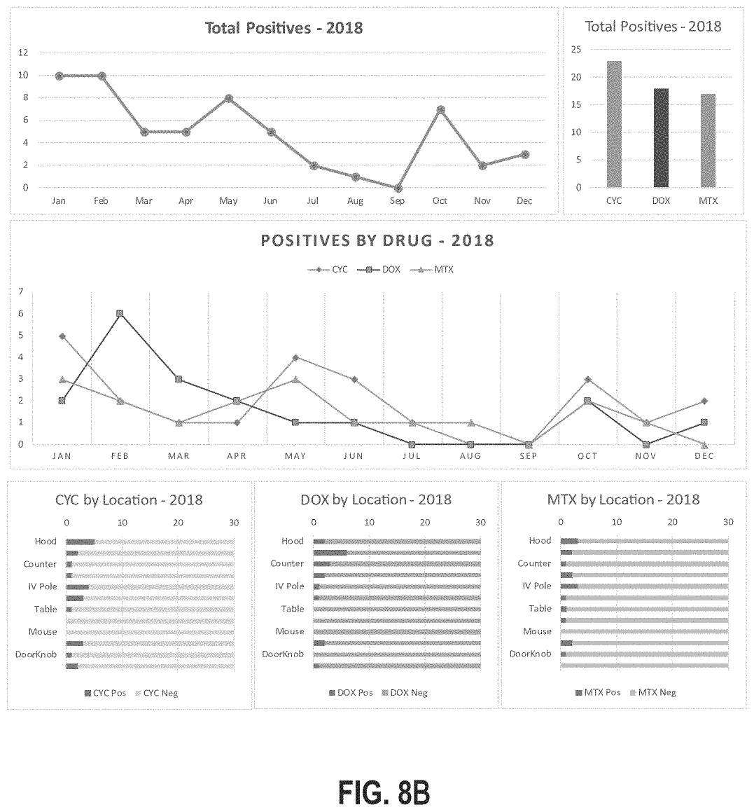

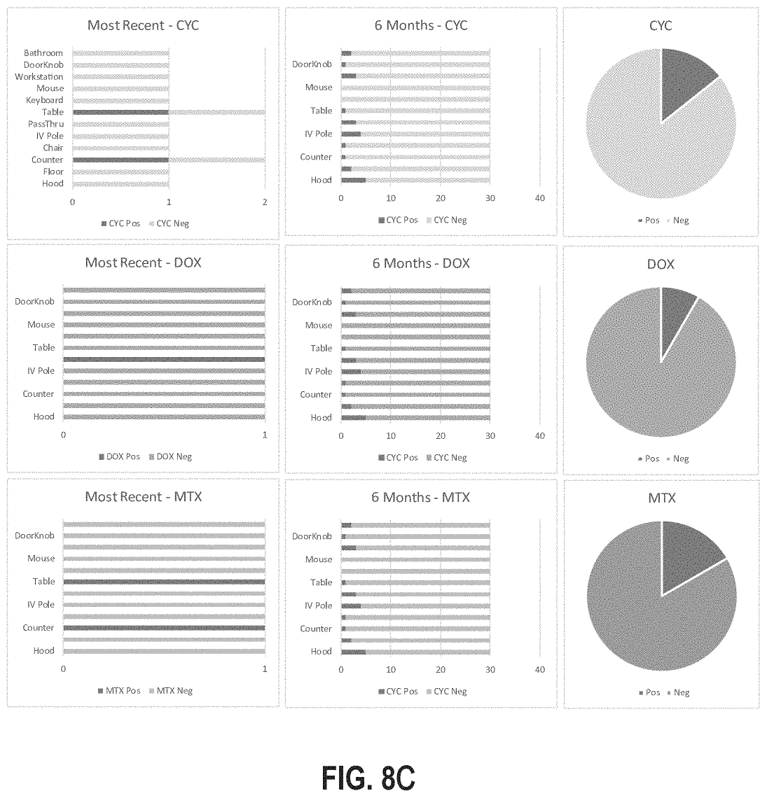

At block 505, test locations are determined. The test locations may correspond to one or more locations as described above with reference to FIG. 2, for example, rooms within a facility and/or one or more surfaces, items, or areas within a room. At block 510, location-specific machine-readable information is generated for the determined test locations. In some embodiments, an alphanumeric location identifier may be assigned to correspond to each physical location. Examples of alphanumeric location identifiers are described in greater detail with reference to FIGS. 8A-8C.

At block 510, location-specific machine-readable information is generated for each test location. In some embodiments, generation of location-specific machine-readable information may include encoding an alphanumeric location identifier into a machine-readable format such as a barcode, QR code, or the like. Additionally or alternatively, generation of location-specific machine-readable information may include identifying an existing machine-readable information item to be utilized as the location-specific machine-readable information for a location. For example, if a determined test location is on or near a piece of equipment that already has a barcode or other machine-readable information item displayed thereon (e.g., an equipment identification code or other code), the existing information already displayed at the location may be used as the location-specific machine-readable information rather than generating new location-specific machine-readable information for the location.

At block 515, the location-specific machine-readable information generated at block 510 is associated with the corresponding location. In some embodiments, the association at block 515 may be performed using the hazardous contamination detection device 300, for example, in a location assignment mode in which the location-specific machine-readable information items (e.g., barcodes) can be scanned at the external scanner 345 to associate the tags with known alphanumeric location identifiers.

At block 520, the location-specific machine-readable information may be applied to sample containers as hazardous contamination testing is performed. In some embodiments, individual location-specific machine-readable information items (e.g., barcodes) can be printed onto a plurality of tags (e.g., stickers, other adhesive labels, or the like). Multiple tags, each containing the barcode or other machine-readable information corresponding to a particular location, may be kept at the location to be subsequently affixed to sample containers used for hazardous contamination testing at the particular location. In some embodiments, the location-specific machine-readable information for multiple locations may additionally or alternatively be kept in proximity to the hazardous contamination detection device 300, such as in a list, a folder, a book, an instruction manual, or the like.

At block 525, a sample is collected from the test location. Various example methods of testing include providing the surface with a buffer solution and wiping the wetted surface with an absorbent swab, or wiping the surface with a swab pre-wetted with the buffer solution. The buffer fluid can have properties that assist in picking up contaminants from the surface. In some implementations, the buffer fluid can have properties that assist in releasing collected contaminants from swab material. The collected contaminants can be mixed into a homogeneous solution for testing. The buffer solution, together with any collected contaminants, can be expressed or extracted from the swab to form a liquid sample. The liquid sample may be placed into a sample container that has been prepared by affixing a location-specific barcode tag to the container, or the barcode tag may be affixed to the container after the sample is obtained. In some embodiments, for example if the sample will be tested at a detection device located at or near the test location, the collected sample may not be physically tagged with a location-specific barcode tag. At block 530, the sample is applied to an assay. For example, at least a portion of the liquid sample may be placed onto an assay 144 contained within an assay cartridge 140 as described with reference to FIGS. 1A and 1B.

At block 535, the prepared assay is tested at a reader device such as the hazardous contamination detection devices 100, 300 described with reference to FIGS. 1A and 3. In some embodiments, the testing includes powering on the reader device and inserting into the reader device the assay cartridge containing the assay. Upon detecting insertion of the assay cartridge, the reader device may display an instruction to provide a location scan. In response to such instruction, a user implementing the method 500 may scan, at the external optical scanner 122 or external scanner 345, the barcode tag affixed to the sample container that held the sample used to prepare the tested assay. In another example, the user may scan a barcode or other machine-readable information item corresponding to the known location where the sample was obtained. For example, the user may scan a location-specific machine-readable information tag present at the test location, for example from a tag affixed to a test location. The assay testing procedure may then continue as described above with reference to FIG. 4.

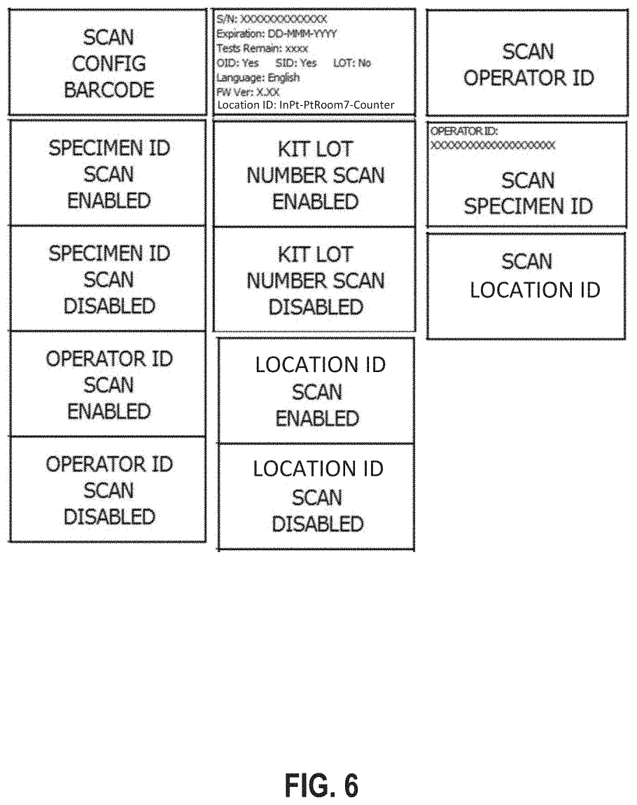

FIG. 6 illustrates example display text that can be presented to an operator of a hazardous contamination detection device, for example, at display 136 of device 100 or at display 350 of device 300. As described above, embodiments of the systems and methods described herein can allow the end-user to customize, on a particular hazardous contamination detection device, the types of information that will be stored in association with test results, significantly increasing compliance and traceability of test results, and reducing transcription and documentation errors. In embodiments including wireless or cellular connectivity capabilities, customized reports including test results associated with selected information categories can be automatically transmitted to a remote server. The top display in the first column of the example displays in FIG. 6 illustrates a display of the hazardous contamination detection device prompting the user to scan a configuration barcode in order to enable a particular type of information to be associated with test results, or to disable the particular type of information from being associated with the test results. In this non-limiting example, after reading the “SCAN CONFIG BARCODE” prompt, the user scans a barcode that instructs the hazardous contamination detection device to enable an operator ID function (if the user wishes to associate and store operator ID information with test results), or the user scans a barcode that instructs the hazardous contamination detection device to disable an operator ID function (if the user does not wish to associate and store operator ID information with test results). In another example, the “SCAN CONFIG BARCODE” prompt may allow a user to scan a barcode that instructs the hazardous contamination detection device to store location information with test results. In yet another example, the “SCAN CONFIG BARCODE” prompt may allow a user to scan a barcode that causes the hazardous contamination detection device to enter a location information assignment mode, described above with reference to block 510 above. After the user scans the barcode indicating the user's selection, the hazardous contamination detection device displays text confirming the user's selection. In this non-limiting example, the hazardous contamination detection device displays “OPERATOR ID SCAN ENABLED” or “OPERATOR ID SCAN DISABLED” to the user. Similarly, the hazardous contamination detection device may display “LOCATION ID SCAN ENABLED” or “LOCATION ID SCAN DISABLED” to the user if the configuration barcode instructs the hazardous contamination detection device to enable the location ID function. The hazardous contamination detection device may then ask the user to enable or disable other types of information functions, such as but not limited to location ID, specimen ID, and kit lot ID (see example display tests in FIG. 6 for instance).

In cases where the location ID function is enabled, the hazardous contamination detection device will now prompt the user to scan a barcode associated with a location ID for each test event. For example, prior to prompting the user to input an assay test strip into the device for analysis, the hazardous contamination detection device will display “SCAN LOCATION ID” to the user, instructing the user to scan a barcode associated with the location ID of the location where a sample was obtained. As described above, the barcode may be located on a sample container holding a sample to be tested or it may be located at the testing site where a sample is collected. The hazardous contamination detection device can sequentially query the user to input particular types of information according to the previously-selected, customized configuration settings of the hazardous contamination detection device. For example, after the user scans a barcode associated with a location ID, the hazardous contamination detection device can next prompt the user to scan a barcode associated with a specimen ID for the test event (see, for example, “SCAN SPECIMEN ID” display in FIG. 6) or an operator IDS (see, for example, “SCAN OPERATOR ID” display in FIG. 6), if the device was configured to request specimen ID or operator ID information. In some cases, the hazardous contamination detection device will not prompt the user to input an assay test strip for analysis until all information required by the particular configuration settings has been entered. In some cases, the hazardous contamination detection device can display a summary of the configuration settings (see, for instance, the example display at the top of the middle column in FIG. 6).

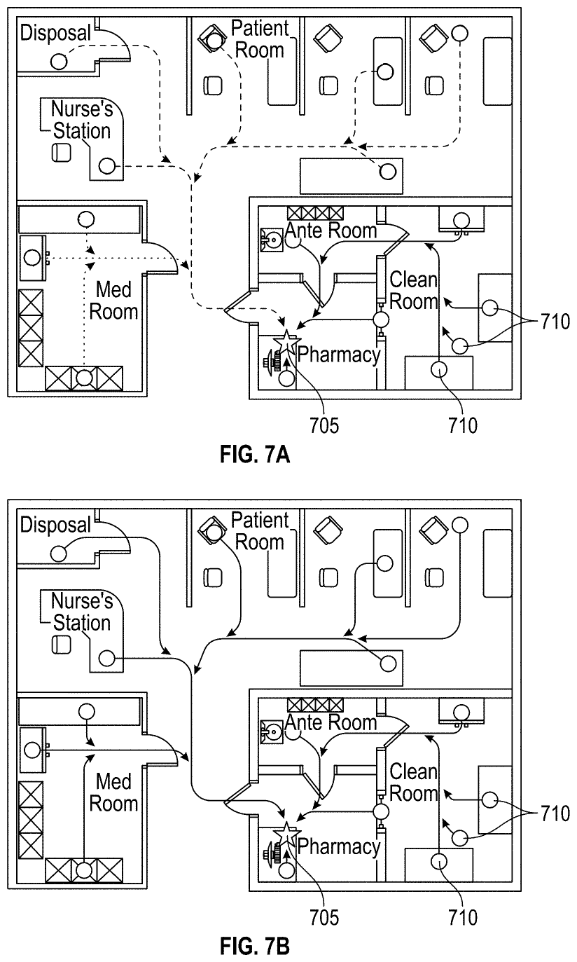

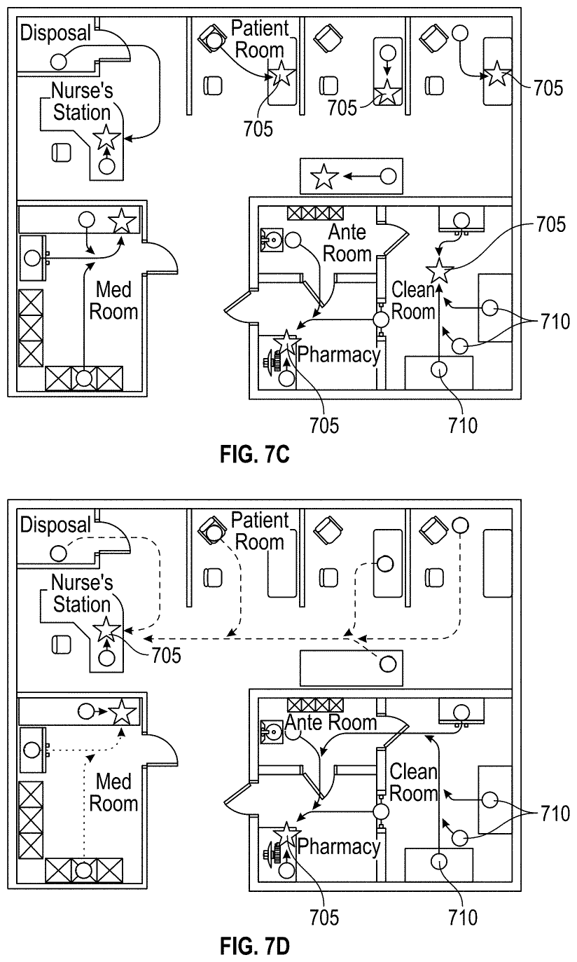

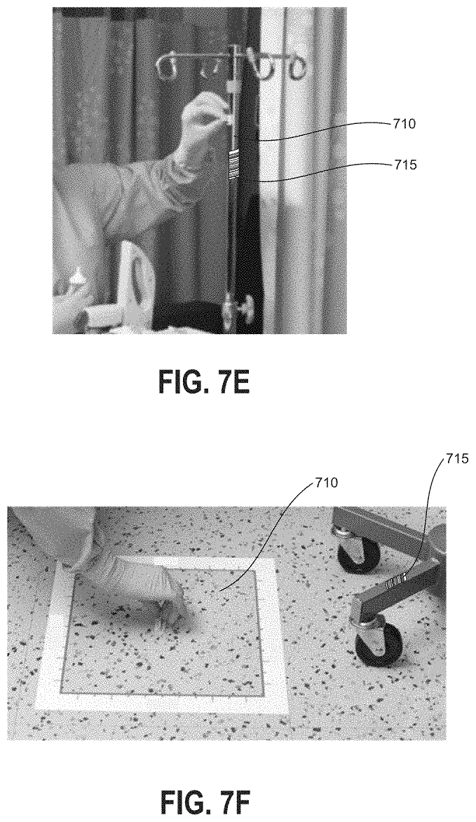

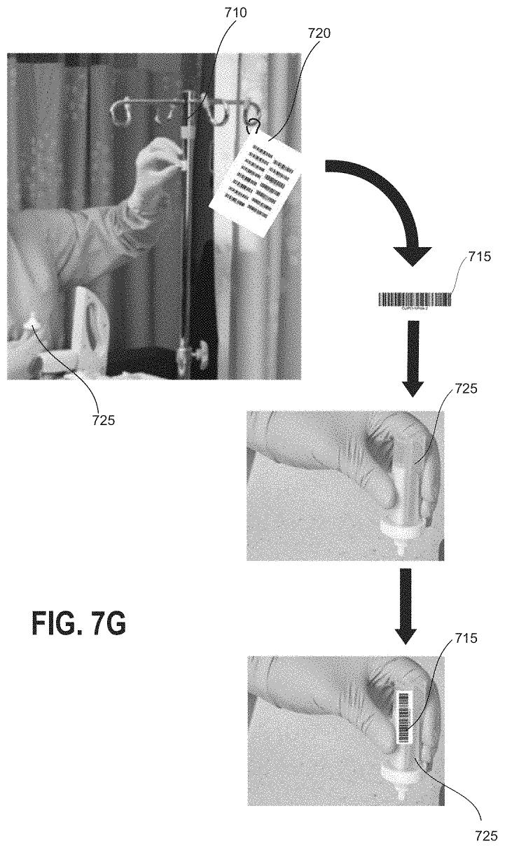

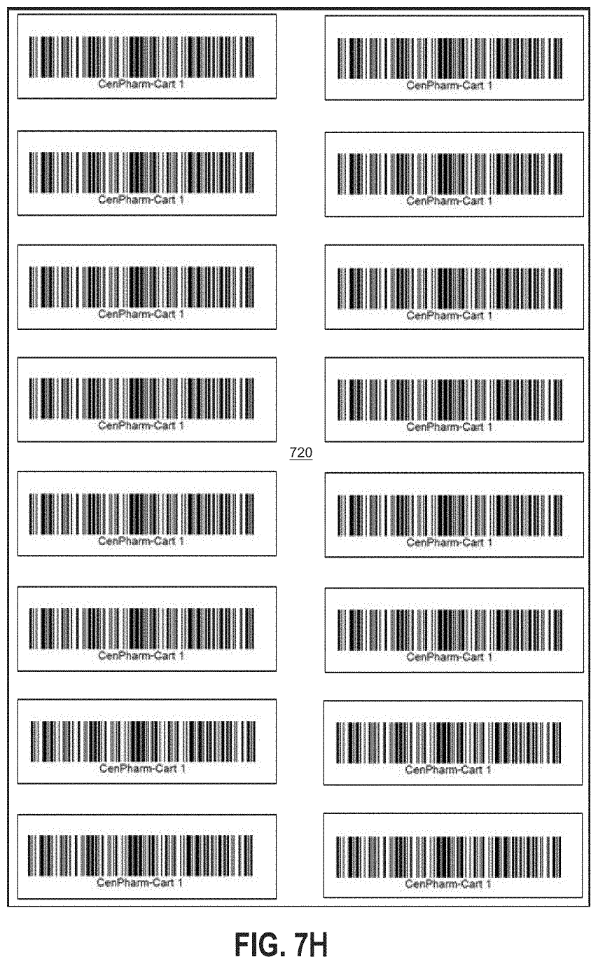

Referring now to FIGS. 7A-7D, a variety of example workflows may be implemented with the systems and methods described herein to efficiently achieve hazardous contamination testing at a plurality of locations within a facility. Each of the workflows depicted in FIGS. 7A-7D is illustrated with reference to the example medical facility 200 illustrated in FIG. 2. However, it will be understood that the workflows of FIGS. 7A-7D are examples and systems and method according to the present disclosure can be implemented in any facility in which hazardous contamination testing is to be performed. Each of the workflows of FIGS. 7A-7D provides a process for testing for one or more hazardous contaminants at a plurality of test locations 710, using one or more hazardous contamination detection devices stored at detector locations 705. For example, a hazardous contamination detection device 100 or a hazardous contamination detection device 300 can be are stored and used by an operator at a detector location 705 after the operator has collected samples at test locations 110. As will be described below, it will be understood that a facility can have a plurality of testing devices each stored at one of a plurality of detector locations 705. It also will be understood that any workflow or combination of the workflows of FIGS. 7A-7D may be selected and implemented at an individual facility based on, for example, a number of rooms to be tested, a number of available hazardous contamination detection devices, a size of the facility, and the like.

FIG. 7A schematically illustrates a first example workflow in which a single hazardous contamination detection device is located at a detector location 705. In the non-limiting example workflow of FIG. 7A, location barcode tags are stored at or near the test locations 710. For example, each test location 710 or room containing a test location 710 may include one or more location-specific tag dispensers. A location-specific tag dispenser can be a printer configured to print location-specific tags; a book, folder, or paper where a plurality of pre-printed, duplicate location-specific tags are stored; or any other suitable dispenser. In one non-limiting example, adhesive labels displaying the corresponding location-specific machine-readable information are provided in a book, folder, or paper stored at the test location 710. Accordingly, a user such as a testing operator may obtain a plurality of empty sample containers (e.g., from a central storage location near the detector location 705), and travel to the various testing locations 710 within the facility. At each testing location 710 where the user will perform a hazardous contamination test, the user selects an appropriate location tag and affixes the location tag to an individual sample container. After performing the test at each location, the user places the obtained sample into the labeled sample container and continues to the next location. After all desired locations have been tested, or after all of the user's sample containers have been used to collect samples, the user may return to the detector location 705. At the detector location 705, the user tests each obtained sample in sequence, for example, by powering on the hazardous contamination detection device; scanning a location-specific barcode affixed to a first sample container holding a sample to be tested when prompted to do so; applying an individual liquid sample from the first sample container to an assay in a first assay cartridge; inserting the first assay cartridge with applied sample into the hazardous contamination detection device; repeating this process with a second sample container and a second assay cartridge; and continuing this process until all collected samples have been tested. Other workflows can be implemented as described above with reference to FIGS. 4 and 5, or any other suitable workflow. The location tag affixed to each sample container allows the user to reliably scan the correct location tag corresponding to the location where the sample was obtained, without requiring the user to remember where individual samples were obtained, and while still permitting the user to collect a large number of samples during a single trip around the facility rather than having to return to the detector location 705 after obtaining each sample.

FIG. 7B schematically illustrates a second example workflow. Similar to the first example workflow of FIG. 7A, the workflow of FIG. 7B utilizes a single hazardous contamination detection device at a detector location 705. In the workflow of FIG. 7B, a supply of pre-printed location tags need not be maintained at each test location 710. Instead, the location tags are prepared and applied to the sample containers at the detector location 705 before a series of samples are collected. Subsequently, upon arrival at each test location 710, the user identifies the pre-labeled sample container corresponding to the test location 710 and places the sampled obtained at the test location 710 into the identified sample container before returning to the detector location 705 to perform testing of collected samples.

FIG. 7C schematically illustrates a third example workflow. Similar to the workflows of FIGS. 7A and 7B, the workflow of FIG. 7C may still be implemented with a single hazardous contamination detection device. However, in the third example workflow of FIG. 7C, the hazardous contamination detection device travels with the user as the user collects samples at the test locations 710. At each test location 710, or within each room, the user may collect one or more liquid samples, and may apply the liquid samples to an assay and test the assay at the test location 710. In some embodiments, the third example workflow of FIG. 7C may be implemented without individually labeling sample containers with location tags. For example, each test location 710 may have a single location-specific machine-readable information tag affixed thereto, such that the user can scan the tag at the test location 710, rather than a tag on the sample container, when the hazardous contamination detection device displays an instruction to provide a location scan. Examples of test locations 710 that can have a single location-specific machine-readable information tag affixed thereto include, but are not limited to, a compounding hood, an IV pole, a medication inventory cart, and a hazardous waste container or non-hazardous waste container in a disposal room.

FIG. 7D schematically illustrates a fourth example workflow. The fourth example workflow can be implemented in a facility including a plurality of hazardous contamination detection devices located at a plurality of detector locations 705. Accordingly, each hazardous contamination detection device can be used to test samples obtained at test locations 710 near the individual hazardous contamination detection device. In some embodiments, the fourth example workflow of FIG. 7D may further reduce the probability of user error by reducing the number of test locations 710 to be tested at each hazardous contamination detection device. The fourth example workflow can be implemented using location barcode tags individually affixed to sample containers as samples are collected at the test locations 710, and/or may be implemented by pre-labeling each sample container before traveling to test locations 710 (e.g., as described with reference to FIG. 7A or FIG. 7B).

FIGS. 7E-7G illustrate example configurations for providing location-specific machine-readable information tags as described above with reference to FIGS. 7A-7D. Although the machine-readable information tags are depicted as barcode tags in FIGS. 7E-7G, it will be understood that any other type of machine-readable information may be used. FIGS. 7E and 7F illustrate embodiments in which individual test locations 710 have a location-specific barcode tag 715 affixed at or near the location. For example, in FIG. 7E the test location 710 is an IV pole. A barcode tag 715 is affixed to the IV pole, such that a user performing hazardous contamination testing in accordance with the workflow of FIG. 7C may obtain a sample, apply the sample to an assay, insert the assay into a detection device, and scan the barcode tag 710 on the IV pole when prompted to provide a location scan by the detection device. Similarly, in FIG. 7F the test location 710 is a section of a floor. In this example, the barcode tag 715 is located near but not directly on the test location 710, for example, affixed to the base of a piece of equipment that remains in the room where the test location 710 is located.

FIG. 7G illustrates an example configuration in which a plurality of barcode tags 715 are provided for use on individual sample containers 725. The plurality of barcode tags 715 may be provided, for example, as a sheet 720 of barcode tags 715 printed on adhesive labels or the like. Accordingly, a user performing hazardous contamination testing in accordance with any of the workflows of FIGS. 7A-7D may travel to the test location 710, remove a single barcode tag 715 from the sheet 720 or other container of barcode tags 715, obtain a sample container 725 to be used for testing the test location 710, and affix the barcode tag 715 to the sample container 725 such that, when a sample is obtained from the test location 710, the sample may be placed directly into a container that is pre-labeled with the correct test location 710, avoiding erroneous location information due to, for example, user error. FIG. 7H illustrates an example sheet 720 of barcode tags 715 as described with reference to FIG. 7G.

FIGS. 8A-8C illustrate example reports that may be generated in accordance with the location-specific hazardous contamination detection systems and methods described herein. As described herein, a customizable reporting function can be handled at the server side or by one or more remote computing devices that are physically separate from the hazardous contamination detection devices but receive information from the hazardous contamination detection devices. For example, test result data and associated information (e.g., location identifiers) from scanned barcodes can be stored in a database of one or more remote computing devices, for example a server system, and the remote computing device can produce customized reports with only fields of interest to the end user. An end user can include but is not limited to a user of the reader device, an administrator in a healthcare facility using the reader device, an entity managing remote server systems, and a public health organization.

The data stored in a hazardous contamination detection device may be obtained via a wired connection, such as through a USB port or other data connection of the device, and/or wirelessly, such as by export via Wi-Fi, cellular data transmission, etc., for example, at a communication module 352 as described with reference to FIG. 3. In some embodiments, transfer of the data, such as a CSV file or other data format, may be enabled by provision of a security credential, such as by scanning an unlocking barcode or other code at the device to unlock and/or initiate data transfer. In some embodiments, the security credential may temporarily unlock USB or wireless access to the memory of the device, such as memory 352 and/or working memory 355 described with reference to FIG. 3, for a predetermined unlocking time period and/or until the next time the device is powered off. Transferred data may then be analyzed using one or more analytical software packages. For example, a suitable analytical software package may be configured to receive data in a preselected format consistent with a format output by the hazardous contamination detection device. In some embodiments, the analytical software package may comprise one or more templates that may be usable and/or executable at least partially in conjunction with one or more commercially available software packages such as a spreadsheet software (e.g., Excel or the like). It will also be understood that analysis and reporting of data may be performed based on the data from a single hazardous contamination detection device and/or based on pooling of data obtained from multiple hazardous contamination detection devices located within a single facility and/or distributed across multiple facilities associated with an end user or other entity.

The example report of FIG. 8A illustrates several example analyses that may be performed automatically based on the data stored at the hazardous contamination detection device from a plurality of tests. A first window 805 of the example report displays the records of individual tests performed at the device. For each line, corresponding to an individual test, the first window displays a date and time when the test was performed (e.g., a time stamp recorded by the device based on a time indicated by an internal clock of the device when an assay cartridge was inserted into the device or adjusted based on an analyzer time correction factor); a location identifier indicating the location where the test sample was obtained (e.g., a location identifier such as “InPt-PtRoom7-Counter” may correspond to a countertop within patient room 7, a location identifier such as “InPt-PtRoom3-IV Pole” may correspond to a surface of an IV pole within patient room 3, etc.); a test name (e.g., an identifier of a substance that was tested for in each test, for example, an antineoplastic agent such as methotrexate or doxorubicin); a test result (e.g., positive or negative for presence of substance); and/or any other relevant information corresponding to each test. The first window 805 may allow an end user to view individual test records. In some embodiments, individual records may be modifiable within the analytical software package, but may be write-protected (e.g., within a write-protected CSV file) on the hazardous contamination detection device, such that the original testing records stored within the device are not affected by any changes made in the process of subsequently analyzing the testing data.

As shown in a second window 810, the individual test results may be aggregated and grouped by one or more criteria such as by test name. In the example report of FIG. 8A, the test name of each individual test was a drug name corresponding to either doxorubicin or methotrexate. In the second window 810, a bar graph displays the number of positive and negative test results for each drug. Such comparison may allow an end user to efficiently evaluate the frequency with which each tested drug is spilled, leaked, or otherwise allowed to contaminate a surface in the facility. For example, if a particular drug is associated with an elevated frequency of positive tests compared with other drugs used in the facility, it may be determined that an aspect of the packaging, storage, handling, administration, or disposal of the particular drug should be modified to reduce the frequency of contamination.

As shown in third and fourth windows 815 and 820, the aggregated individual results may also be grouped by location-specific criteria. For example, window 815 is a bar graph illustrating the relative numbers of positive and negative results for each location for methotrexate (“MTX”), and window 820 is a bar graph illustrating the relative numbers of positive and negative results for each location for doxorubicin (“DOX”). In some embodiments, a location-specific report may be generated for a combination of multiple test names (e.g., a location-specific report for methotrexate and doxorubicin tests combined). Comparison of positive and negative test results by location may allow an end user to efficiently evaluate the frequency with which contamination occurs at individual locations. For example, if a small subset of locations within a facility are associated with an elevated frequency of positive tests compared with other locations within the facility, the end user may be better able to identify and mitigate any causes of such elevated frequency. Example causes of a location-specific high frequency of contamination may include the type and location of hazardous drug storage in the location, individual personnel who handle the hazardous drugs in a particular location, or other factors. This information can help establish the cause of elevated contamination incidents is operator error or an untrained operator, rather than, for example, a product flaw in a hazardous drug storage or dispensing system.

In addition to the particular analyses depicted in FIG. 8A, it will be understood that a variety of additional analytical methods may be possible with the systems and methods described herein. For example, the data obtained at one or more hazardous contamination detection devices may enable analysis of trends in positive results by time, by day of the week, by time of day, by time of the year, by operator, by location (e.g., for individual contaminants or for a plurality of contaminants), by contaminant, by department or sub-department, by ratio of positive to negative results by location or generally, by frequency of testing by variable, etc. The systems and methods herein may further provide for analysis of error code results, re-test identification and result linking, changes in results for samples collected before and after surface cleaning, and post-spill testing.

FIG. 8B illustrates an example report in which data is aggregated by year. As shown in FIG. 8B, the data obtained from one or more hazardous contamination detection devices over the course of a specified time period (e.g., a calendar year such as 2018, a fiscal year, a month, multiple years, or other time period) may be analyzed to identify various trends in the data. The example report of FIG. 8B is based on data regarding timestamped and location-tagged positive and negative results of tests performed to detect three hazardous contaminants (e.g., antineoplastic drugs cyclophosphamide, doxorubicin, and methotrexate). Accordingly, the data collected using the systems and methods described herein enables preparation of reports such as that of FIG. 8B, which allows an end user to see useful data trends such as total positive results by month, total positive results by individual contaminant, positive results by month and by individual contaminant, and positive vs. negative results broken down by individual location for each individual drug.

FIG. 8C illustrates an example “current report” in which the hazardous contamination testing results are aggregated to provide an up-to-date report on current trends in hazardous contamination at the facility. Similar to the report of FIG. 8B, the report of FIG. 8C depicts positive and negative results of testing aggregated for each of cyclophosphamide, doxorubicin, and methotrexate. A first column of the report of FIG. 8C depicts the most recent result (e.g., positive and/or negative for the most recent test(s) performed at each test location). A second column depicts the total positive and negative results over a preceding period ending at the current time (e.g., the last 6 months, or any other desired time period ending at the current time). A third column depicts total positive and negative results for each contaminant tested, for example, over the same 6-month period or any other desired time period.

It will be understood that any of the analyses and/or information display formats depicted within the reports of FIGS. 8A-8C may be included in combination and/or with any other suitable information display format in a report generated based on the data obtained by the hazardous contaminant detection systems and methods described herein.

The systems described herein may further be configured to provide automated alerts to one or more end users based on analyzed test data. For example, alerts may be provided to one or more end users when a scheduled test is overdue at a particular test location, or for scheduled events such as re-test reminders, scheduled test alerts, assay expiration warnings, duplication alerts, etc. Accordingly, the systems and methods described herein may additionally be used to monitor compliance with intended testing schedules.

The described systems and methods can collect, detect, and track trace amounts of antineoplastic agents and/or chemotherapeutic drugs in some embodiments. It will be appreciated that the described systems can be adapted to collect and detect quantities of other biohazardous chemicals, drugs, pathogens, or substances in other embodiments. Further, the disclosed systems can be used in forensic, industrial, and other settings.

### Implementing Systems and Terminology

Implementations disclosed herein provide systems, methods and apparatus for a modular, reconfigurable assay reader. One skilled in the art will recognize that these embodiments may be implemented in hardware or a combination of hardware and software and/or firmware.

The assay reader device may include one or more image sensors, one or more image signal processors, and a memory including instructions or modules for carrying out the processes discussed above. The device may also have data, a processor loading instructions and/or data from memory, one or more communication interfaces, one or more input devices, one or more output devices such as a display device and a power source/interface. The device may additionally include a transmitter and a receiver. The transmitter and receiver may be jointly referred to as a transceiver. The transceiver may be coupled to one or more antennas for transmitting and/or receiving wireless signals.

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. A computing environment can include any type of computer system, including, but not limited to, a computer system based on a microprocessor, a mainframe computer, a digital signal processor, a portable computing device, a personal organizer, a device controller, and a computational engine within an appliance, to name a few.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It should be noted that the terms “couple,” “coupling,” “coupled” or other variations of the word couple as used herein may indicate either an indirect connection or a direct connection. For example, if a first component is “coupled” to a second component, the first component may be either indirectly connected to the second component or directly connected to the second component. As used herein, the term “plurality” denotes two or more. For example, a plurality of components indicates two or more components.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like. The phrase “based on” does not mean “based only on,” unless expressly specified otherwise. In other words, the phrase “based on” describes both “based only on” and “based at least on.”

The previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

What is claimed is:

1. A hazardous contamination detection device comprising:
a housing configured to receive an assay cartridge at least partially within the housing, the assay cartridge containing an assay;
an optical sensor within the housing positioned to detect changes in optical characteristics of the assay following application of a test sample to the assay, the optical sensor configured to generate a signal indicating the detected changes in optical characteristics of the assay;
a first optical scanner configured to image first machine-readable data from an object external to the housing;
a second optical scanner within the housing configured to image second machine-readable data from the assay cartridge when it is at least partially received within the housing;
at least one processor; and
a memory having instructions stored thereon that configure the at least one processor to:
determine, based on the first machine-readable data imaged at the first optical scanner, location information identifying a test location corresponding to the assay cartridge;
determine, based on the second machine-readable data imaged at the second optical scanner, additional information associated with the assay;
determine a test result based at least partly on the additional information and the signal generated by the optical sensor; and
automatically store the test result in association with the location information in the memory.

2. The hazardous contamination detection device of claim 1, wherein the at least one processor is configured to use the additional information to establish operating parameters of the hazardous contamination detection device.

3. The hazardous contamination detection device of claim 1, wherein the assay comprises a lateral flow assay, and wherein the signal generated by the optical sensor is indicative of a positive or negative result corresponding to the assay.

4. The hazardous contamination detection device of claim 1, wherein the additional information identifies a contaminant the assay is configured to detect.

5. The hazardous contamination detection device of claim 1, wherein the assay is configured to detect the presence of one or more antineoplastic agents within a liquid sample applied to the assay.

6. The hazardous contamination detection device of claim 1, wherein the at least one processor is configured to store the additional information in association with the test result.

7. The hazardous contamination detection device of claim 1, wherein the additional information comprises at least one of: a development time corresponding to the assay, an operating parameter for the hazardous contamination detection device corresponding to the assay, and a name corresponding to a drug the assay is configured to detect.

8. The hazardous contamination detection device of claim 1, further comprising a communication module configured for wireless data transmission, wherein the instructions further configure the at least one processor to cause the communication module to wirelessly transmit, to a remote data store, the test result in association with the location information.

9. The hazardous contamination detection device of claim 1, wherein the first machine-readable data and the second machine-readable data each comprise a barcode, and wherein the first optical scanner and the second optical scanner each comprises a barcode scanner.

10. The hazardous contamination detection device of claim 1, further comprising a display and a sensor configured to detect insertion of the assay cartridge into the housing, wherein the instructions further configure the at least one processor to:
detect insertion of the assay cartridge into the housing;
display, in response to detecting insertion of the assay cartridge, an instruction to a user to scan the first machine-readable data at the first optical scanner; and
cause the first optical scanner to image the first machine-readable data.

11. The hazardous contamination detection device of claim 1, further comprising a sensor configured to detect insertion of the assay cartridge into the housing, wherein the instructions further configure the at least one processor to:
detect insertion of the assay cartridge in the housing; and
cause the second optical scanner to image the second machine-readable data.

12. The hazardous contamination detection device of claim 1, wherein the memory stores a comma-separated values (CSV) file containing values indicative of previously performed tests, and wherein storing the test result comprises editing the CSV file to add one or more values indicative of the test result and the location information.

13. The hazardous contamination detection device of claim 1, wherein the first optical scanner is housed within a module removably received at least partially within the housing.

14. A method of location-specific testing for hazardous contaminants, the method comprising:
determining a plurality of test locations for hazardous contaminant testing;
generating a plurality of location-specific machine-readable information tags, each machine-readable information tag associated with one of the plurality of test locations;
collecting a first sample from a first test location of the plurality of test locations;
applying the first sample to an assay disposed within a first assay cartridge, the assay cartridge comprising additional machine-readable information identifying a contaminant the assay is configured to detect;
inserting the first assay cartridge into a hazardous contamination detection device;
scanning, at an optical scanner of the hazardous contamination detection device, a first location-specific machine-readable information tag of the plurality of location-specific machine-readable information tags, the first location-specific machine-readable information tag associated with the first test location; and
removing the first assay cartridge from the hazardous contamination detection device in response to an indication of a test result displayed by the hazardous contamination detection device.

15. The method of claim 14, further comprising:
collecting a plurality of second samples from a plurality of second test locations of the plurality of test locations;
applying the plurality of second samples to individual assays disposed within second assay cartridges;
inserting individual second assay cartridges into the hazardous contamination detection device; and
scanning, for each individual second assay cartridge, individual second location-specific machine-readable information tags of the plurality of location-specific machine-readable information tags, each second location-specific machine-readable information tag associated with a second test location corresponding to the individual second sample applied to the second assay cartridge.

16. The method of claim 15, wherein collecting the plurality of second samples comprises placing each second sample into an individual sample container, the method further comprising, prior to inserting the individual second assay cartridges into the hazardous contamination detection device, affixing the individual second location-specific machine-readable information tags to the individual sample containers, wherein each individual second location-specific machine-readable information tag is scanned after the second sample contained therein has been at least partially transferred to an individual second assay cartridge.

17. The method of claim 16, wherein affixing each individual second location-specific machine-readable information comprises obtaining one of a plurality of substantially identical tags stored at or near the corresponding second test location, and affixing the obtained tag to the individual sample container.

18. The method of claim 16, wherein the individual second location-specific machine-readable information tags are affixed to second sample containers at a tag storage location remote from at least some of the plurality of test locations.

19. The method of claim 15, wherein the hazardous contamination detection device is a portable device, wherein each first or second assay cartridge is inserted into the hazardous contamination testing device at or near one of the plurality of test locations, and wherein, for each first or second assay cartridge, the scanning comprises scanning a machine-readable information tag affixed to a surface at or near the one of the plurality of test locations.

20. The method of claim 14, wherein scanning the first location-specific machine-readable information tag causes, at least in part, the hazardous contamination detection device to optically analyze the assay to determine a test result, and to append the determined test result and a test location identifier to a comma-separate values (CSV) file stored within a memory of the hazardous contamination detection device.

21. The method of claim 14, wherein collecting the first sample comprises obtaining a liquid sample and storing the liquid sample within a sample container, the method further comprising affixing the first location-specific machine-readable information tag to the sample container.
